(19) United States
(12) Patent Application Publication
(10) Pub. No.: US 2022/0383259 A1
(43) Pub. Date: Dec. 1, 2022

(54) DYNAMICALLY EVALUATING THE CONSISTENCY, BIAS, LEGITIMACY, OR INTENDED EFFECTS OF EMPLOYMENT POLICIES

(71) Applicant: Syndio Solutions, Inc., Seattle, WA (US)

(72) Inventors: Maria Colacurcio, Bellevue, WA (US); Robert Porcarelli, Seattle, WA (US); Robert Paul Platzer, Saugerties, NY (US); Kathlyn Bardaro, Snoqualmie, WA (US); Zev Eigen, Amsterdam (NL); Olya Evanitsky, New York, NY (US); Courtney Alexandra Ellert, Tucson, AZ (US); Melania Davila, North Alington, NJ (US); David Rubin, Danbury, CT (US); Rebecca Scully, Seattle, WA (US); Clinton Cutchins, Charleston, SC (US); Vanessa Mari Lynskey, Seattle, WA (US); Allison Hamilton, Seattle, WA (US); Robert Christopher Martin, Seattle, WA (US); Erika M. Johnson, Seattle, WA (US); Tyler E. Benjamin, Arlington, TX (US); Heather R. Kanipe, Highland Park, IL (US); Adam Joshua Reed, Denver, CO (US); Heather L. Hendy, Westminster, CO (US); Brendon Alan Kay, Golden, CO (US); Trent Vigar, Atlanta, GA (US); Taivon David Thompson, Brooklyn, NY (US); Samuel Andres Roldan, Astoria, NY (US); Lena I. Ripple, Seattle, WA (US); Joshua B. Hanson, Marrero, LA (US); Olga Kuznetsova, Newcastle, WA (US); John Dillon Lareau, Pittsburgh, PA (US); Scott J. Wilkins, Seattle, WA (US); Michelle Elaine Ruch, Ridgefield, WA (US); Jessica Sarmiento Madamba, Elk Grove, CA (US); Jia Yin, Jersey City, NJ (US)

(21) Appl. No.: 17/826,025

(22) Filed: May 26, 2022

Related U.S. Application Data
(60) Provisional application No. 63/193,595, filed on May 26, 2021.

(51) Int. Cl. G06Q 10/10; G06Q 10/06; G06Q 40/00

(52) U.S. Cl. CPC G06Q 10/105; G06Q 10/063; G06Q 40/125

(57) ABSTRACT

Disclosed are example embodiments of a methods and systems for analyzing and determining impact (or lack thereof) on any selected group or groups of employees of selected pay policies. An example includes a computer-implemented method for analyzing and determining impact on selected group of employees of selected pay policies. The method including receiving a first pay data for the selected group of employees. The method also including determining one or more controls for the selected group of employees. Additionally, the method including calculating an equitable pay range for the selected group of employees based on the one or more controls. The method also including receiving a user input, wherein the user input requests a second pay data relates to an employee, and is based on a selected control. The method also including calculating the second pay data; and sending the second pay data for display.

### CLAIM OF PRIORITY UNDER 35 U.S.C. § 119

The present application for patent claims priority to Provisional Application No. 63/193,595 entitled “PAY POLICY ANALYTICS AND PAY FINDER” filed May 26, 2021 and assigned to the assignee hereof and hereby expressly incorporated by reference herein.

### TECHNICAL FIELD

The disclosure generally relates to the field of human resources and employment practices, and specifically and not by way of limitation, some embodiments are related to dynamically evaluating the consistency, bias, legitimacy, or intended effects (as expected effects) of employment policies within an organization or company.

### BACKGROUND

Employers need to understand which factors within their control contribute to the pay gap between men and women or the pay gap among workers of different races and ethnicities (or other protected categories). The pay gap refers to the all-up difference in mean or median total annualized compensation for the workers in one organization. These factors include pay equity concerns (e.g., ensuring that workers performing similar work are compensated similarly) and opportunity equity concerns (e.g., ensuring that workers are offered similar opportunities for hiring, performance review, retention, promotion, and advancement at non-statistically significantly different rates by gender, race or other protected category statuses). This work requires employers to discern whether and to what extent their policies operate as expected, and are not contributing to gender or racial bias (or bias against other protected categories). This process also requires employers to comply with various state and federal laws. These laws include pay equity laws (e.g., the California Fair Pay Act “CAFPA”); disclosure requirements around pay gap (average and median compensation reporting); and related laws, statutes and regulations at the federal, state, and local levels. Doing this requires aggregation, harmonization and consolidation of data (including individual level information, group level information, and policy information) and statistical analysis. For instance, the data can include employee gender, race, compensation, functional area, job title, educational attainment, years of experience, years of service, level, and performance rating, to name just a few of the relevant fields. Then, analysis of the data needs to be performed in real time or as close to it as possible to ensure that proposed adjustments are not “stale.” Having access to updated analyses based on current data may be used for organizations to be able to render meaningful decisions based on the insights derived from the results. Information gleaned from the data and analysis thereon needs to be useful and actionable such that business leaders can use the results to determine how to make any necessary adjustments.

It would therefore be desirable to provide a method, system, and technology platform for providing the real-time dynamically adjusting means of performing statistical analysis and providing relevant data and output to enable users to make changes to their business policies and practices in a meaningful way consistent with the laws, the company's intentions, and related considerations. Some embodiments of the present invention may meet these or other needs.

### SUMMARY

Disclosed are example embodiments of methods and systems for analyzing and determining impact (or lack thereof) on any selected group or groups of employees of selected pay policies.

Disclosed are example embodiments of a computer-implemented method for analyzing and determining impact of selected pay policies on a selected group of employees. The method includes receiving first set of pay data for the selected group of employees. The method also includes determining one or more controls for the selected group of employees. Additionally, the method includes calculating an equitable pay range for the selected group of employees based on the one or more controls. The method also includes receiving user input, wherein the user requests a second set of pay data related to other employees, market pay and related information, and is based on a selected control or set of controls. The method also includes calculating the requested second set of pay data; and sending the second set of pay data for display.

Disclosed are example embodiments of a system for analyzing and determining impact on a selected group of employees of selected pay policies. The system includes a memory and at least one processor, coupled to the memory. The memory including instructions causing the processor to: receive a first set of pay data for the selected group of employees, determine one or more controls for the selected group of employees, calculate an equitable pay range for the selected group of employees based on the one or more controls, receive a user input, wherein the user input requests a second set of pay data that relates to an employee, and is based on a selected control, and calculate the second set of pay data; and sending the second set of pay data for display.

Disclosed are example embodiments of a system for analyzing and determining whether individuals of different protected category statuses (e.g., gender, race, ethnicity) have equitable access to opportunities to advance within a given organization, as compared with an internal reference population (e.g., do women employees have equitable access to promotions compared with men employees within the organization). These determinations are based on robust statistical analysis and provide novel insights for organizations to (1) proactively identify issues and correct them; and/or (2) retroactively evaluate actions to learn what impact they had and remediate and/or identify how to prevent similar outcomes in the future.

Disclosed are example embodiments of a system for analyzing and determining the representation of individuals of different protected category statuses (e.g., gender, race, ethnicity) for their job titles or job descriptions as compared to a matched set of Standard Occupational Classification (“SOC”) designations from the Bureau of Labor Statistics in order to render standardized, harmonious comparisons to the available qualified localized or national labor pool.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 illustrates an exemplary high-level topology of a system of the present disclosure.

FIG. 2A is an exemplary high-level diagram showing a process for operating the system and applications of the present disclosure.

FIG. 2B is an exemplary high-level diagram showing a process for Pay Finder Calculation Flow.

FIG. 2C is an exemplary high-level diagram showing a process for Pay Finder File Upload.

FIG. 3 illustrates an example user interface of the present disclosure.

FIG. 4 illustrates an example user interface of the present disclosure for selecting controls.

FIG. 5 illustrates an example user interface of Pay Policy Analytics for displaying/reviewing the controls that have been selected.

FIGS. 6A to 6C illustrate an example user interface of the present disclosure for viewing a selected group.

FIGS. 7A to 7C illustrate an example user interface of Pay Policy Analytics.

FIGS. 8A to 8C illustrate an example user interface of Pay Policy Analytics. In this example, the system displays analysis based on gender data.

FIGS. 9A to 9C illustrate examples of embodiments of an exemplary user interface of the system, including a pay range tool with which users may calculate the equitable and competitive ranges for adding new hires, lateral moves or promotions to a group. FIG. 9D shows an example of Pay Finder settings with which the user can customize and parameterize the user interface.

FIG. 10 illustrates an exemplary overall platform (e.g., server, device, etc.) in which various embodiments, implementations and process steps disclosed herein can be implemented.

FIG. 11 is a diagram illustrating pay gaps in accordance with the systems and methods described herein.

FIG. 12A to 12B illustrate an example user interface of OppEQ Representation.

FIG. 13 illustrates another example user interface of OppEQ Representation

FIG. 14A to 14C illustrate another example user interface of OppEQ Representation.

FIG. 15 illustrates another example user interface of OppEQ Representation.

FIG. 16A to 16B illustrate an example user interface of OppEQ Forecaster.

FIGS. 17A to 17B illustrate an example user interface of OppEQ Equitable Movement.

FIG. 18 illustrates an example user interface of OppEQ Equitable Movement.

FIG. 19 illustrates an example user interface of OppEQ Equitable Movement.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of example systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using various components, hardware, electronic hardware, computer software, or any combination thereof. Whether such elements are implemented as hardware or software depends upon the particular application and design constraints imposed on the overall system.

Provided herein are embodiments of methods, systems, and technology platforms for analyzing and determining the impact (or lack thereof) on any selected group or groups of employees of selected pay policies (e.g., tenure, city, education, years of relevant experience, etc.). Insights include determining whether these policies are valid, show bias towards certain employees based on any protected category status (e.g., male vs. non-male, white vs. non-white) or based on a status defined by the user (e.g., left-handed versus right-handed), how the customer's actual pay practices deviate from their stated pay practices, and whether the data, the models and their underlying assumptions are valid.

In an example embodiment, one or more of the different analytics or analysis discussed above may be grouped within workplace analytics. In an example embodiment, an example process may analyze any overall gap, then perform one or more of the aspects described herein, such as, for example, PayEQ, Pay Finder, and Pay Policy Analytics. An example embodiment may also perform an OppEq.

Embodiments of methods and systems of the present disclosure also provide practical application to, and improve technologies in, the analyzing and determining of impact (or lack thereof) on any selected group or groups of employees of selected pay policies. The methods and systems of the present disclosure further improves computer-based functions in analyzing and determining of impact (or lack thereof) on any selected group or groups of employees of selected pay policies.

Personnel who make compensation and benefits decisions at organizations may want to ensure that these decisions are made with at least three constraints in mind. For example, first, these decisions should be made in a way that is consistent across individuals based on protected category status and other grouping constraints in terms of how different policies are weighted. For instance, how much of the variation in compensation is due to location versus due to educational attainment or tenure. Second, these decisions need to be made in a way that correlates compensation appropriately and consistently and as expected/intended. For instance, for each additional year of tenure, how much additional compensation is expected and how much is actually paid to employees. Third, these decisions need to be made in a way that is compliant with state, federal and local laws and such that the policies themselves are not the source of bias as how they are applied to different categories of individuals. For instance, does an additional year of tenure correlate with more compensation paid to men as compared to women? And so on.

In an example embodiment, the constraints, such as the three categories of criteria above, may need to be made in a way that is insightful and based on current data, which may update periodically as the organization changes and individuals are hired, promoted, and exit the organization. The information about the policies may need to be dynamic such that the user may change things and see how the results are impacted in real time. In some implementations, the present system may integrate statistical software, construct specific combinations of graphs, output and analysis automatically, dynamically and in real time. By contrast, results from calculations and graphical renderings made by hand are very often “stale” and not useful because the organization has changed in between the time when the data were extracted and when the analysis was complete. Additionally, consumers of this information almost invariably need to make changes to the underlying information on which the calculations are based, so without this invention, that is not possible.

In some implementations, the system and method described herein may provide output (e.g., graphs and other information) that may be dynamically updated, selected, including completely changing how and which employees are included or excluded in the analysis, and which form or forms of compensation are being analyzed.

In some embodiments, the methods and systems of the present disclosure can include a platform (may be referred to as “PayEQ”) that can include a plurality of features. For example, the platform can include Pay Policy Analytics and Pay Finder feature sets. Some example embodiments may include workplace analytics, which may be used to analyze one or more of the aspects of the work environment or the workplace as described herein.

In some embodiments, the methods and systems of the present disclosure can include a platform (may be referred to as “OppEQ”) that can include a plurality of features. For example, the platform can include pay gap insights, SOC matching, analysis of equitable or fair movement in the organization (e.g.: hiring, lateral movement, performance evaluation, promotion, retention).

Pay Policy Analytics

In general, Pay Policy Analytics can be a major first step in providing a robust and dynamic root-cause analysis toolset. It can also help users (may also be referred to herein as customers) understand the impact of their policies on pay. In the context of these analyses, these policies are referred to interchangeably as “controls” used in the statistical models rendered herein. In some implementations, controls may include, for example: Geo Zone (region), City, State, Time in Role, Age, Years of Relevant Experience, Tenure in Years, Level, Manages People, Performance Score, Educational Attainment, Legacy Hire, just to name a few. In some embodiments, it may provide insights into pay practices and uncover pay-related problems, including, for example: how the organization's actual pay deviates from their stated practices; whether controls have bias toward certain employees; whether a user's controls are valid and defensible; whether the data, the models and their underlying assumptions are valid, etc.

In some embodiments, the system of the present disclosure may include root cause analysis. In general, root cause analysis is a systematic process for identifying root causes of issues that lead to unfair workplace practices and an approach for responding to them. Instead of merely putting out fires as they develop, this type of analysis is meant to identify ways to prevent those issues and avoid repeated need for remediation. At a high level, it can involve analyzing data, surfacing issues and their causes, and identifying and prioritizing solutions. Once a solution is implemented, it can also involve monitoring and sustaining the change. For example, a root cause analysis may help understand what to change in the future so the same pay gap issues do not come back.

In some embodiments, the system may include Pay Policy Analytics, which can include, in general, control evaluation and root cause analysis. For example, controls may be data that represent policies used to explain legitimate differences in pay. In some implementations, analyzing those controls for root causes entails providing insights in how the controls relate to pay and uncovering any bias in the controls.

In some embodiments, Pay Policy Analytics may include an anchor toolset for determining certain root causes, for example, the root cause of pay equity gaps in an organization. By analyzing known controls, as well as data not explicitly set as controls, the system can provide insights, for example, into pay practices—such as whether the controls are valid drivers of pay differences or are inherently biased—as well as what may be influencing pay beyond the stated pay practices.

In some embodiments, the system may include root cause analysis. In some implementations, root cause can be next-level analysis the users can bring to bear on their pay practices after an initial pay equity analysis. Pay Policy Analytics may be the first step in developing a root cause toolset. With Pay Policy Analytics, organizations can understand the impact of their controls on pay and learn if they have policies for which the data shows it is not actually fitting a model of how they pay. Pay Policy Analytics may be an opportunity to provide the users with insights into pay practices, for example, whether their controls are valid, have bias towards certain employees, how the user's actual pay deviates from their stated pay practices, whether the data, the models and their underlying assumptions are valid, and so on.

In some embodiments, the system may analyze, fix, and then monitor pay equity issues.

Some embodiments may also provide the users with continuous analytics and recommendations. As described above, some example embodiments may include workplace analytics.

In some example implementations, a user may start with conducting a pay equity analysis to find and fix pay gaps and then can progress to understanding the root causes of why those pay gaps existed and fixing those. Pay Policy Analytics can arm the user with data-driven actionable insights. It can promote healthier behavior while providing value after core analysis and remediation is complete.

Pay Finder

Unlawful pay disparities are an ongoing problem for most companies, leading to potentially enormous remediation budgets and persistent compliance concerns. Many times, biased pay decisions are the root cause of this issue. For example, new hire offers may be based on external market rates, negotiation, and manager discretion, with no clear line of sight into what is internally equitable. Bias influences decisions and equity erodes with every hire. Even when there is no bias in how offers are made, there may be differences in the propensity and efficacy of negotiations on the part of the offerees that may result in unlawful, biased, or otherwise inequitable differences in compensation rates.

In some embodiments, Pay Finder can provide insights and recommendations that guide compensation decisions and ensure starting salaries are competitive and equitable. Pay Finder can allow a user to find the ideal salary for every new hire that is competitive and equitable; eliminate remediation fees by preventing pay disparities; reduce legal risk by being in compliance every day, not once a year; and allow customers to build their “fair pay” brand by ensuring equitable pay from day one, just to name a few benefits.

In some implementations, users may use the system to find, modify, optimize and improve their pay equity issues. However, after each successive analysis/remediation cycle, pay equity issues may be reintroduced and they need to fix what is newly broken. One of the major causes of that reintroduction is starting pay—how compensation is set for new hires, as well as for lateral moves, promotions or other changes in employment titles, status or positions. Starting pay decisions often involve a lot of discretion and therefore can easily offset an organization's pay equity balance.

In some embodiments, the system of the present disclosure may provide a toolset for users to set starting pay (called “Pay Finder”), wherein the toolset can prevent pay equity issues from occurring and make, or help the users make decisions throughout the year for starting pay in accordance with already-established pay equity. In some implementations, users may use Pay Finder as a solution to fix existing pay equity issues. The system may drive user behavior by providing the information needed to make discretionary choices in the right context and to successfully get people onboard at an equitable pay.

In some embodiments, Pay Finder can provide and present an “equitable pay” range along with a market range, so a user can immediately find the sweet spot between the two. With Pay Finder's predictive pay equity insights capability, the user can enter any salary and instantly see its impact on pay equity, helping the user to maintain fair pay with every new hire as well as with incumbent employees when they are promoted or laterally transferred to new positions, levels or other functional areas within the organization. With real-time salary trends features, the user can access salaries for recent hires and employees doing similar work, helping the user to identify real-time compensation trends.

All user interfaces and views can be customized. This can provide different users, like recruiters, with a custom view and insights, streamlining offer creation while ensuring fair pay.

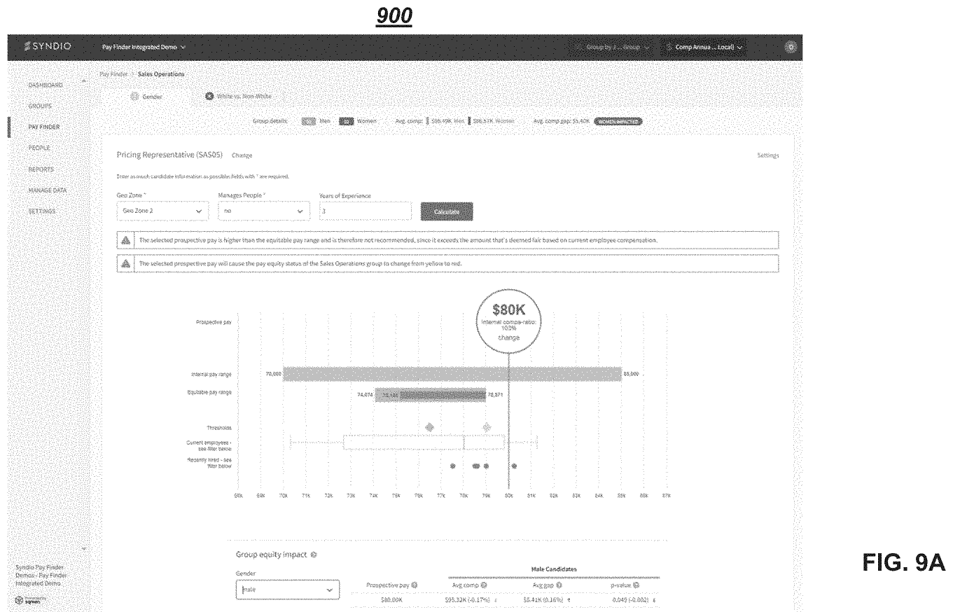

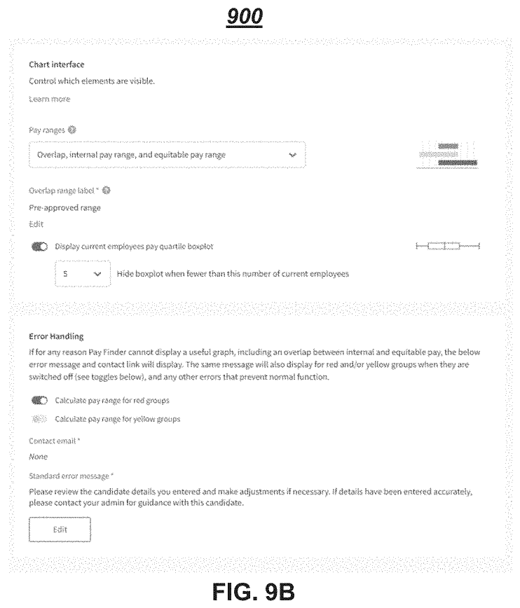

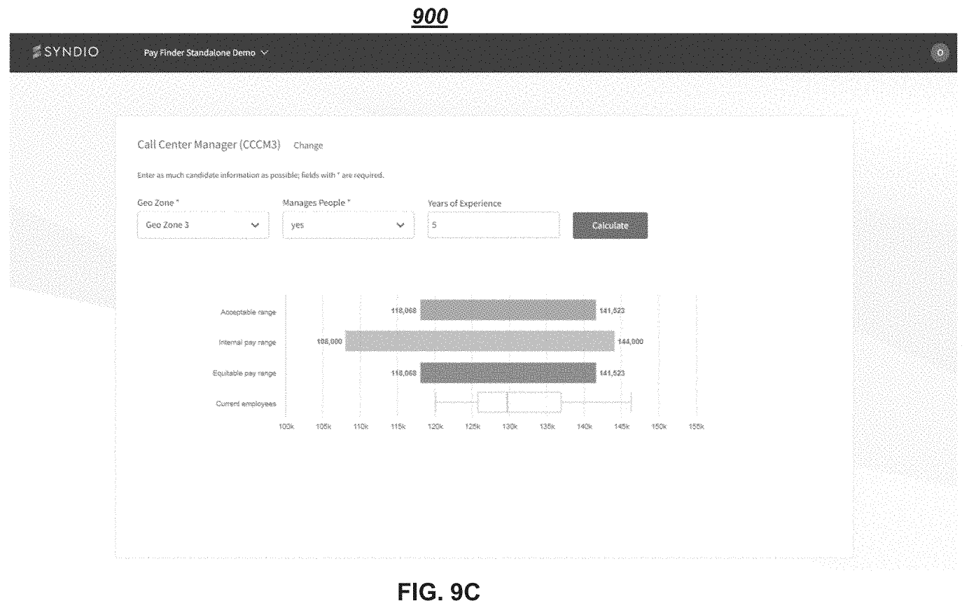

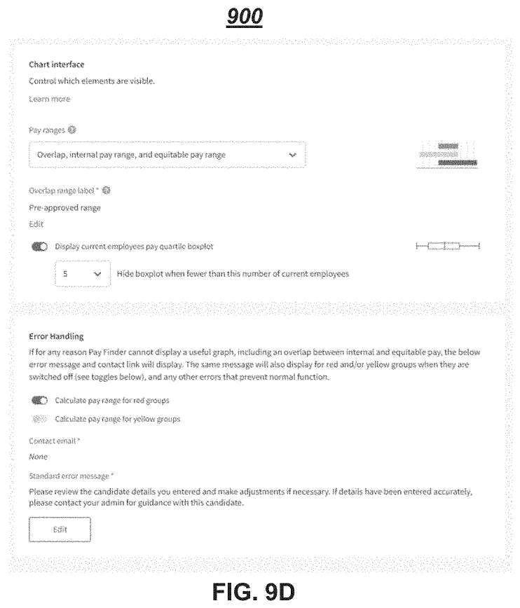

In some embodiments, as shown in an exemplary user interface 900 of FIG. 9A, the system may include a pay range tool that users can use to calculate the range for adding an individual new hire to a group of employees subject to review. In some implementations, the tool may not be job specific, for example, it does not take the user's defined pay ranges into account (so it can present a range for a job beyond what a user would pay). In some implementations, the tool may only provide one range at a time. In some implementations, the tool may be only available for groups identified as not showing statistically significant disparities (color coded as green in the software) and may be only available to the select senior comp professionals who use the system, and not the wider array of employees involved in the hiring process. In some implementations, the toolset can solve all these limitations, open the system to new user personas and also provide a host of powerful analytical features and integrations related to starting pay.

In some exemplary operations, users of the system may include compensation teams who are responsible for determining competitive wages and who are often responsible for vetting individual starting pay decisions within an organization. These may include senior compensation professionals and their wider staff. The users may also include talent acquisition/ recruiters responsible for finding, acquiring, assessing, and hiring prospective candidates and need a framework for making offers. Additional users may include hiring managers, HR business partners, and in-house counsels.

Some terminology is provided below to understand further details of the system.

Pay range: The upper and lower limits of compensation, typically including a minimum, midpoint, and maximum. It may identify what spread of pay can apply to a given job. It may also be called “salary band.”

Pay grade: An identifier of a range and multiple jobs that can be grouped into the same grade. Jobs with similar internal and market value may be assigned the same range of pay and in the same grade.

Range midpoint: The exact middle of the range, equidistant to the range minimum and range maximum, and aligned to the market value for the job. In a grade and range structure, all jobs of a similar market value may be assigned to a grade with a range midpoint that is closest to the average market value. The midpoint may also be considered the proficiency point for the job.

Compa-ratio: How an employee pay rate compares to the midpoint of their range. Calculated as Pay Rate÷Range Midpoint.

Range penetration: Where an employee pay rate falls within the internal pay range. Calculated as (prospective pay−range minimum)÷(range maximum−range minimum)

Status threshold: Within Pay Finder, a status threshold allows a user to see the exact compensation amount that would flip a group's current pay gap status; for example, from green to yellow.

Geographic differentials: Additional compensation paid to an employee to account for variations in cost of labor and/or cost of living between locations.

Compression: Wage compression is a phenomenon that occurs when a new hire is paid the same as or more than employees with more seniority in the same job.

Incumbent: An individual already employed by a user organization.

ATS: Applicant tracking system; an application that enables the electronic handling of recruitment and hiring needs.

In some exemplary operations, users may find a job, enter related compensable factors, and receive an offer amount that is both equitable and that fits within the pay range the organization has defined for the job. As part of this, a user can see the immediate effect of the hire's (or incumbent employee's internal movement) prospective compensation on pay equity and can test alternate numbers. This includes how the hire would impact the average compensation and gap of the group of employees who do substantially similar work, as well as whether the resulting changes are statistically significant (in what direction the hire moves the p-value, if at all, and whether the change makes the group's pay equity status better or worse). Users may also get offer numbers for groups that are flagged as showing a statistically concerning issue with the differences in distributions of comp (flagged as red in the software) or groups that show marginally statistically significant gaps—e.g., p>=0.05 and p<0.10, sometimes referred to as “approaching statistical significance” (groups can be color coded). Similarly, the user can see the immediate effects of a transferred or promoted incumbent employee's prospective compensation on pay equity and can test alternate numbers.

In some other exemplary operations, the system may provide robust forecasting tools that allow users to model a range of what-if scenarios and see the effect of adding batches of employees. The system may also allow the users to ask and answer questions related to hiring and pay equity. Some example questions may include:

What if I hire 10 engineers and 9 are men?

How many female candidates at what salary do I need to hire to get my Senior Management group to green?

What type of candidate should I be adding into my technicians group based on existing incumbents?

What if I lower the years of experience required for a role?

In some embodiments, the system may include HRIS integration. For example, the integration may include updating to account for a continuous flow of data.

In some embodiments, the system may include ATS integration. For example, an ATS integration feature may be included as a feed directly within a user's ATS system, so recruiters can see pay equity recommendation directly within their job requisitions and do not need to log into a separate system. As such, the system may match recommendation into job requisitions and being able to integrate with the ATS systems. Common ATS systems include Oracle HCM Suite, Lever, Workday Recruiting, SAP Success Factors, ICIMs, SmartRecruiters, Workable, Kronos, Greenhouse, among others.

In some embodiments, the system may provide customization and permission layers that allows the Pay Finder toolset to fit within an organization's hiring and pay practices and that allows the right level of access for all users.

In some embodiments, the Pay Finder toolset may scale to large numbers of users. For example, it may scale to 1000, 1500, or more recruiters on the user's staff.

In some embodiments, the Pay Finder toolset may provide trends over time (such as a year-over-year analysis of starting pay's impact on pay equity, how incumbent ranges compare to market pay, offers made outside of recommended ranges, predictive analytics for determining characteristics of future hires, analysis of “lost” candidates, surfacing of groups with common starting pay problems, etc.).

In some embodiments, the Pay Finder toolset can also include these features:

1. Starting Pay trends over time.
Mathematical evaluation of whether longitudinal trends are spurious or likely genuine
Show progress & meaningful lasting change, automate insights.
   Which practices are driving compensation and likelihood of advancement? E.g.,: Does the organization reward longevity as much as or greater than output?
      Higher salaries consistently being offered in engineering.
      These managers consistently propose higher rates for men.
   Surface the groups with common starting pay problems
   How starting pay is shifting equity.
   Pay equity difference(s) made by using the application.
      Especially if getting greener through hires: e.g.: evaluation of the return on investment of using the tool and a way to track progress made

2. Capture & analyze history of negotiations.
Where do offers start & end?
Negotiation results of males vs. females (or other comparisons like white vs. non-white)?
How was pay adjusted based on market rates?
Ensure recruiters are approaching recruiting in the same way

3. How often are job offers going outside ranges?
Above the incumbents?
Going into yellow territory/outside the equitable range?
Being made at the top of the ranges and by whom?

4. Provide a way to make sure the recruiter follows the advice or does something with it.
Preserve the range used to make the decision.
Have an adherence notification system.

5. See which candidates we missed out on and why.
Better understand industry landscapes and changes to those landscapes over time.
   E.g., COVID changed retail, likely forever; analytics would help provide insights

6. Surface differences between market data vs. internal range data.
For instance, some employers use externally calibrated levels such as those promulgated by Radford (associated with Aon). Radford leveling data should harmonize with internal ranges; if they do not, users need to know why.
   For compensation not correlated w/externally calibrated level data (e.g., Radford data); figure out where variations are introduced and why.

7. Track how consistent hiring and compensation practices are across departments.
Includes tracking how “experience” is measured/determined.

8. What percentage of non-whites has the organization promoted in the previous six months?

9. Surface meaningful comparisons/alerts with incumbents.
E.g., Is a new hire's salary higher than a woman's with significant tenure?
Context is important; what's the why? This is out of range, but why? [00077] 10. Aspirational weightings

The user does not have experience or a new location in the existing employment data, but wants to set an aspirational weight (e.g., $1,000 for every year of experience plus $500 for location X);
Easy to model

11. More predictive analytics.
Provide a recommendation & predict the future based on current data.
   E.g., Currently the organization has 10 males and 5 females with a set of attributes and levels of contributions to work, and the recommendation is this type of person, these qualities, these salaries.
   Take into account things that happen in the market in the future and predict that moving forward.
Candidates who start at certain point of year are not eligible for merit increases; so offer should take this into account.

12. Forecasting

On demand report for managers to make on-cycle (e.g., pre-merit planning reports with comp ratio and performance rating) and off-cycle pay decisions (for example: where the employee is compared to peers—high, low, performance rating, time in the role, comp ratio, etc.).

13. Surface compression between new hire pay and manager pay

14. Benchmarking
Compare starting pay statistics to other similar companies.
   Number of offers made? What is the number (and ratio) of offers made to women? To people of color?
      Dashboard: Hired 10% women this year vs. 5% last year.
   How often going above equitable ranges? How often staying w/in?
   Am I better than that person over there?
   Compare starting pay offers made to men and women.
      E.g., Female offers lower by x % within tech; or compared with companies of comparable size.

15. Job Description Analysis
Analyze job descriptions using AI to surface similar jobs & compare their compensation
   If job is not priced, find comparables.
   Rely not only on the specific job or role, but on similar job content and skill sets to map and compare using consistent observable metrics.
   Use a word analyzer to ensure postings are not gender or racially biased.
   Auto-populate compensable factors based on candidate resume or, e.g., Linkedln profile.

In some embodiments, the system can include an analytical tool set. For example, the analytical toolset can include the following features:

1. Determine total impact of an exception decision.
“What's the cost of adjusting everyone else?”
“Is it a $200 decision or a $50,000 decision?”

2. Trends
Movement of new hires
Year-over-year analysis

3. Alerts for “hot jobs.”

4. Recruiters going outside of their ranges.

5. Unexpectedly low or high number of people for this type of job.

6. Forecasting performed once per quarter (or similar cadence) and on demand if/when recruiting ramps up.

7. Tools with focus on skills
Need for skills ontology/inventory.
Create internal marketplace & compare skill to skill (skillset analysis).
Project-based employment within a company.
Look for skills internally & externally.

In some embodiments, a system of the present disclosure may include one or more user devices, for example, mobile devices and laptops, electronically coupled to one or more servers via a network. The network may be private or may be public, such as the Internet. The servers may be cloud based. Each user device may include at least one processor, a non-transitory computer-readable medium including computer-executable program instructions executable by the processor, a network interface, a user control interface, and data storage for storing at least a software application that, when executed, may activate content displayed on a display of the user device. The content displayed may be engaged by the user to generate signals transmitted from the user device to the server. The server may include at least one processor, a non-transitory computer-readable medium including computer-executable program instructions executable by the processor, and a network interface configured to operatively connect the server in electronic communication with the mobile devices. In some embodiments, as described further below, the server may be or may include a cluster of servers, or distributed servers.

The mobile devices may be or may include a smartphone, iPad, iPod, tablet, digital watch, portable computer, or any other suitable mobile device.

Software, such as a mobile application, may be downloaded or otherwise installed on the user device.

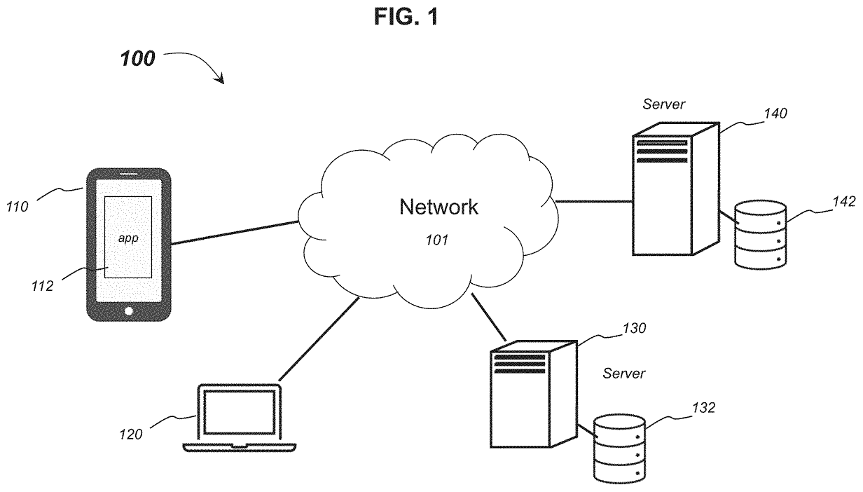

FIG. 1 illustrates an exemplary high-level topology of a system 100 of the present disclosure. The system 100 may generally include one or more servers, for example servers 130 and 140, which may also be third-party server, which may be distributed on one or more logical and/or physical servers, each having one or more processors, memory, data storage, an operating systems, input/output interfaces, network interfaces, and other components and modules implemented in hardware, software or combinations thereof as are all known in the art, and a plurality of end user computing devices 110 and 120 coupled to a public network 101, such as the Internet and/or a cellular-based wireless network. The servers each may include non-transitory computer readable memory storing instructions that, when executed by the processor may create dynamic media content that may include texts, still image and/or an embedded moving image, and send the dynamic media content to one or more user devices for display. The user devices may include, for example, mobile device, desktop or laptop device, or any device with communication and networking capability. A mobile device may include smart phone, tablet, smart watch and other wearables, or other network ready device. The user devices may include one or more processors, memory, data storage, an operating system, input/output interfaces, network interfaces, and other components and modules implemented in hardware, software or combinations thereof.

An application, or application software, may be downloaded or otherwise installed on the user device.

The servers may be or may include a back system. The system may be configured as a cloud-based topology. In some embodiment, the system may be configured with one or more servers which may be distributed. The system may include one or more database or database clusters.

In various embodiments described herein, various functions and features may be part of an application located in the user device, and/or may be located in one or more servers, and/or may be located in a combination of server and user device.

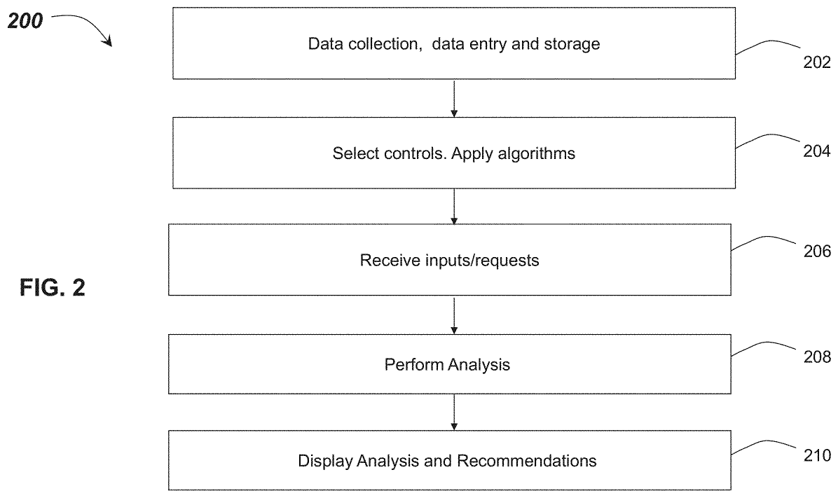

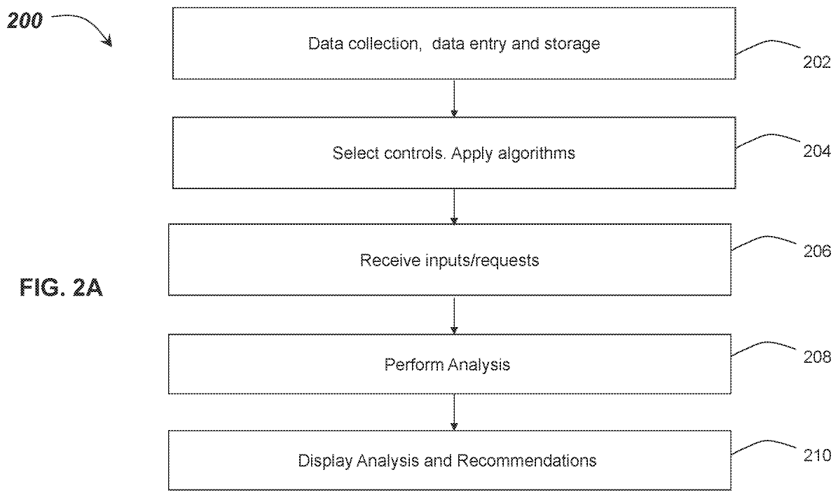

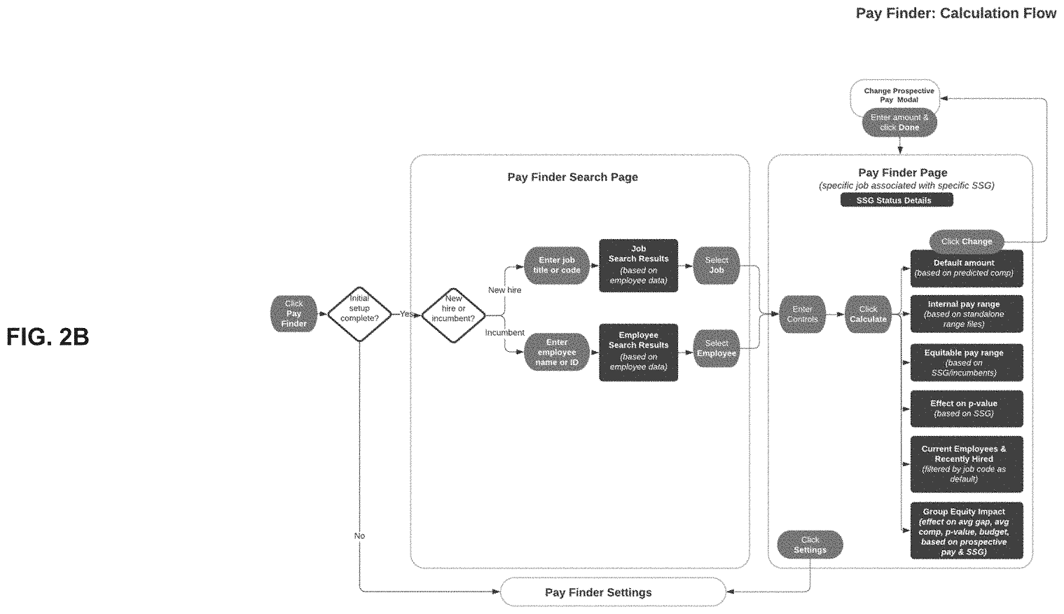

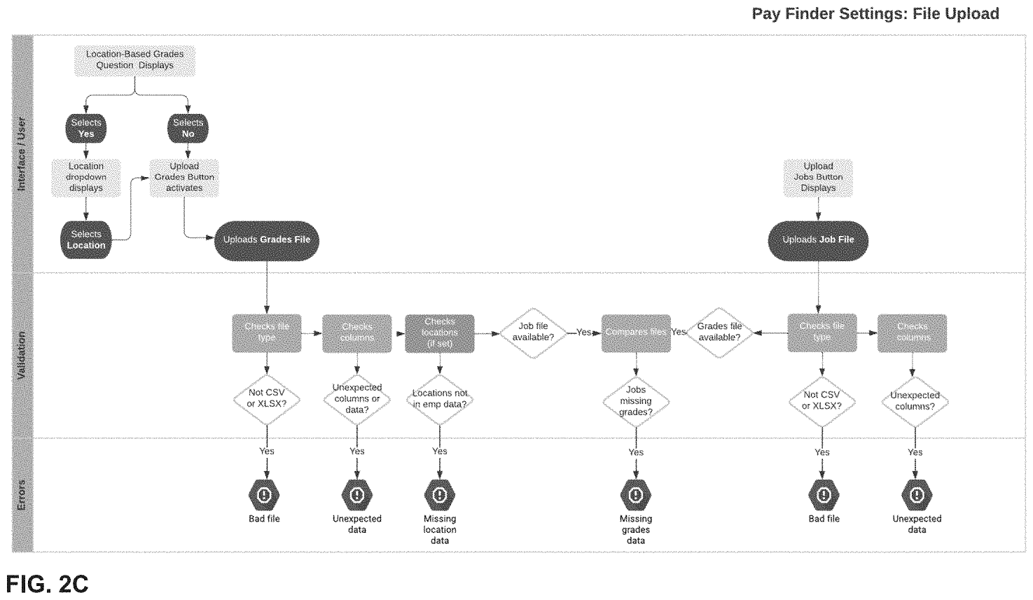

FIG. 2A is an exemplary very high-level diagram showing a process for operating the system and applications of the present disclosure.

FIG. 2B is an exemplary high-level diagram showing a process for Pay Finder Calculation Flow. In some embodiments, the process can include the flow for a user to search for a job and calculate Pay Finder results.

FIG. 2C is an exemplary high-level diagram showing a process for Pay Finder File Upload. In some implementations, the process can include validation for uploading the files needed to display the market pay range in the Pay Finder.

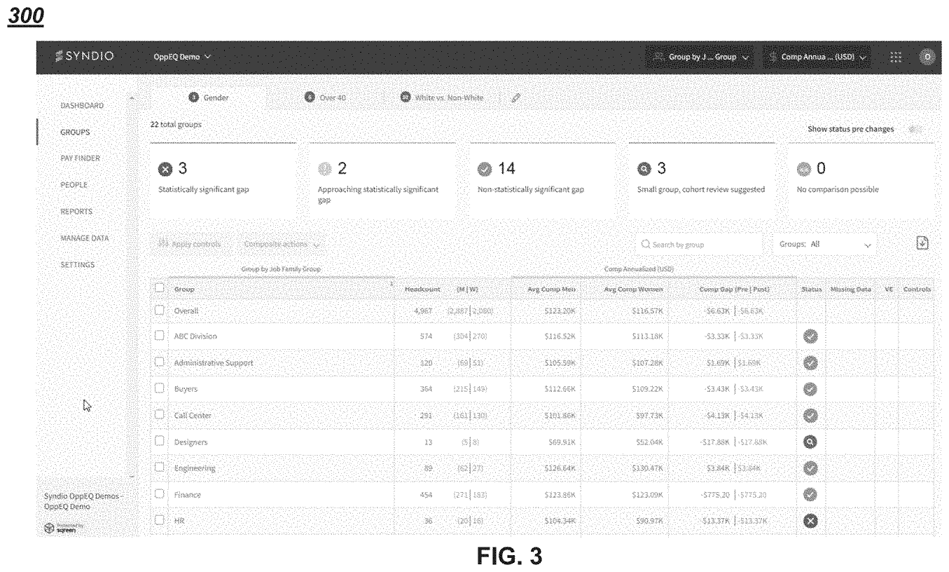

FIG. 3 shows an example user interface 300 of the present disclosure. In this example, data from a user organization has been gathered and stored in a database. The data may relate to employee employment and pay. For example, title, department, experience, pay, level, management, non-management, location, gender, age, etc. As shown, the user interface 300 may present data using Group by Function. Exemplary functions may include, for example, Research and Development, Support, Attorneys, Designers, Executive, Facility Services, HR Specialists, Sales, Technicians, IT, Engineering, and so on. The user interface 300 may also include the head count of each function (may also include counts in Male and Female), Average Compensation for Male and Female employees, Compensation Gap between Male and Female employees, etc.

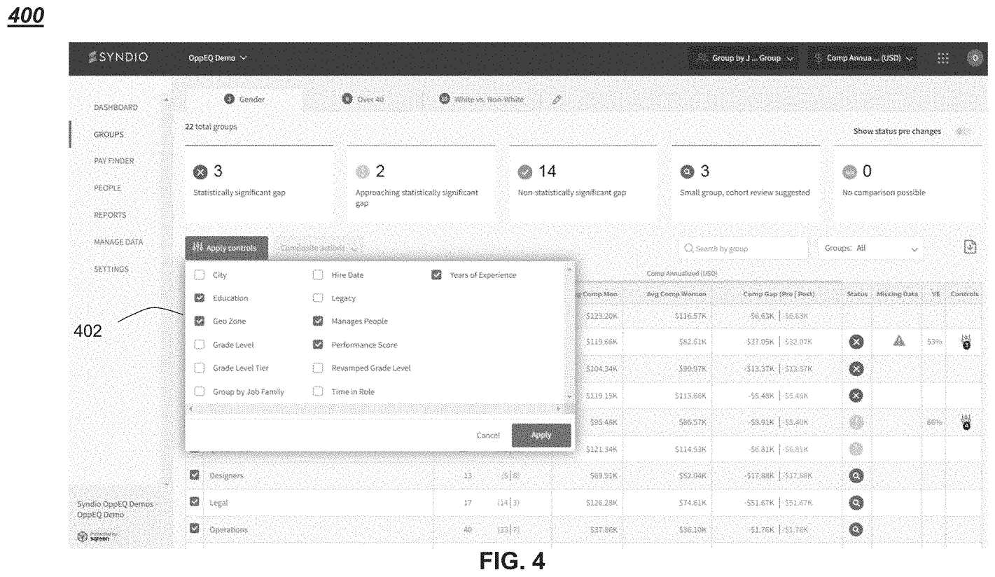

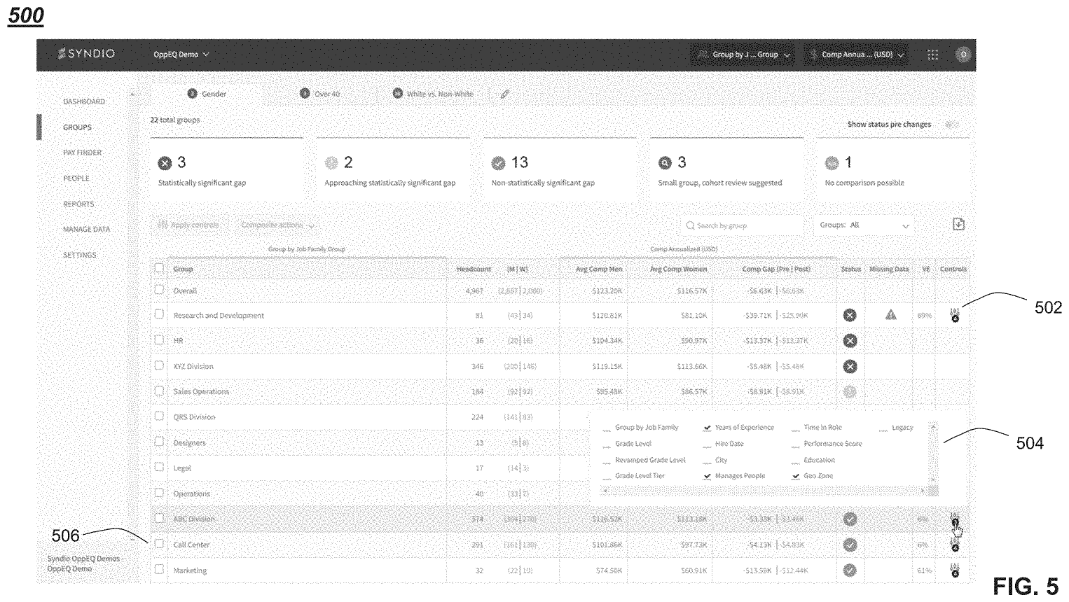

FIG. 4 shows an example user interface 400 of the present disclosure for selecting controls. In this example, the user has selected some controls 402, for example, Geo Zone, Years of Relevant Exp, Tenure in Years, Manage People, and Education. FIG. 5 shows an example user interface 500 of Pay Policy Analytics for displaying/reviewing the controls that have been selected. Icon 502 shows the number of controls selected, and once icon 502 is selected (clicked), window 504 shows the controls selected for the Research and Development group.

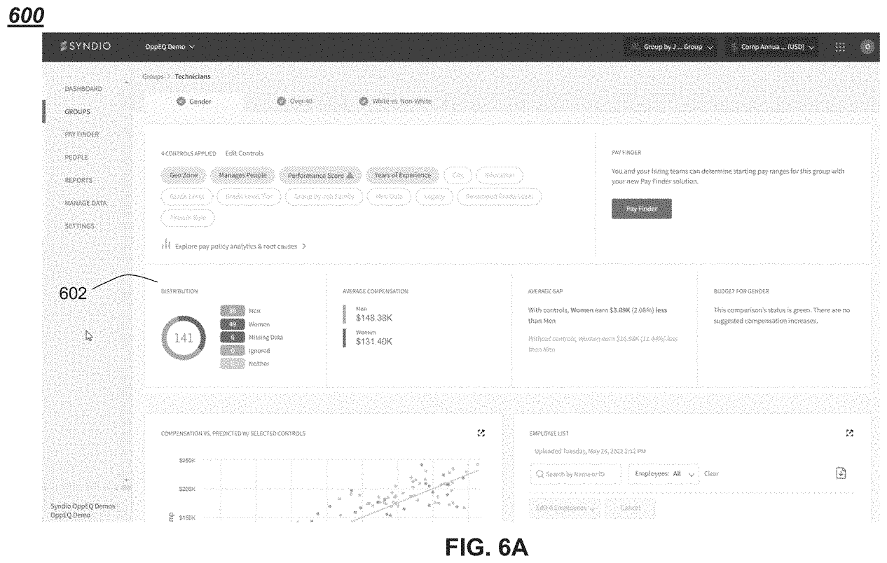

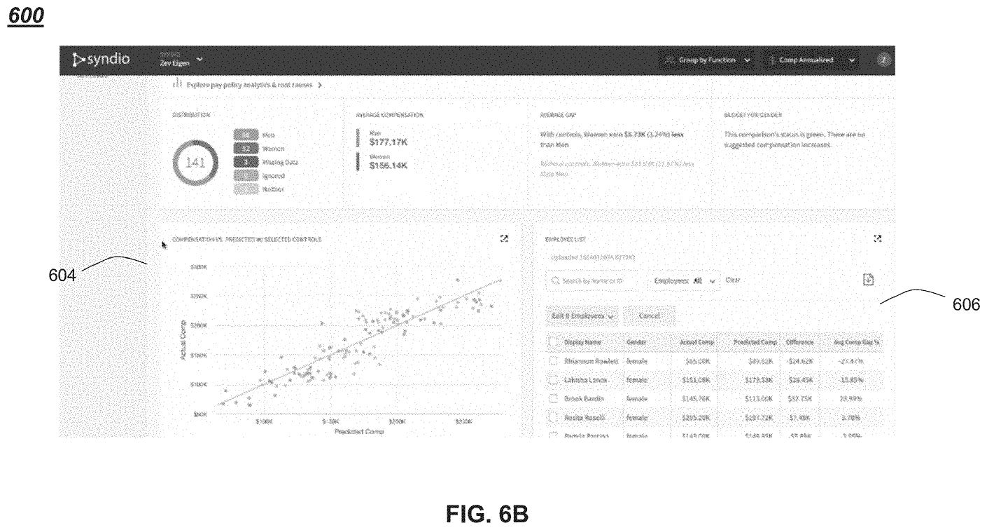

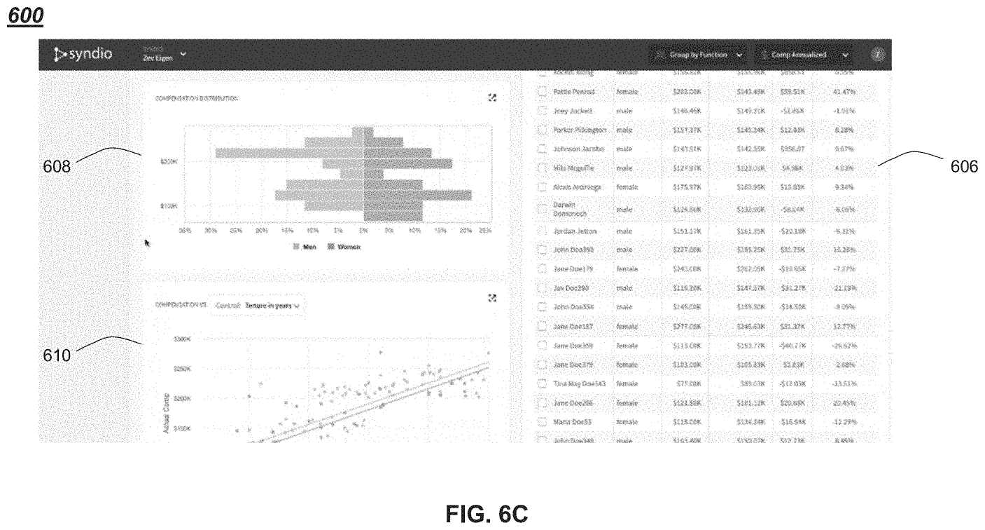

FIGS. 6A to 6C show an example user interface 600 of the present disclosure for viewing a selected group. In this example, the system displays user interface 600 upon the user selected the Technician group 506 in FIG. 5. As shown in FIG. 6A, the system displays various detail of the group in windows 606. The system has received the detail from input provided by the user.

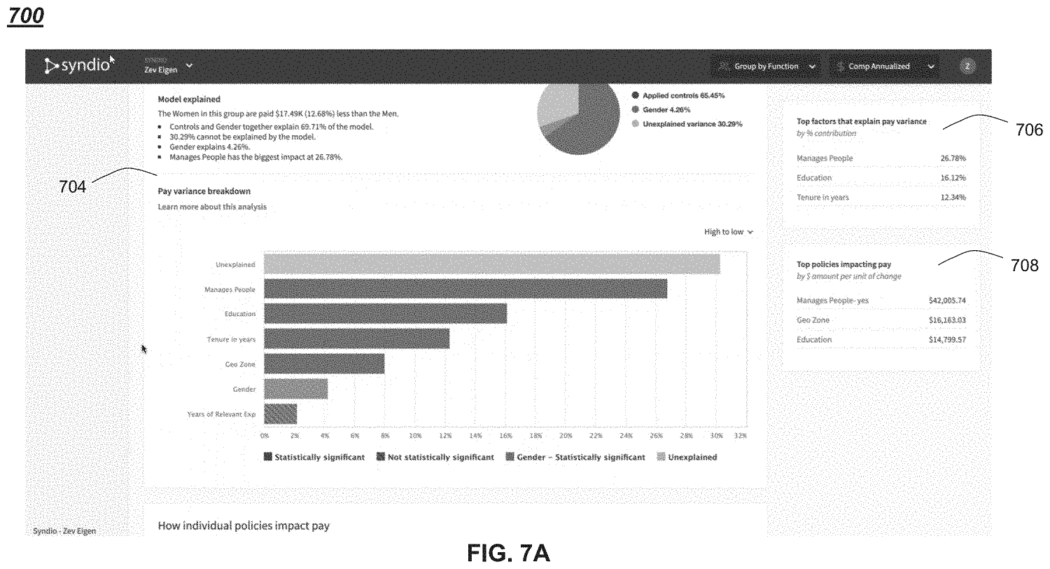

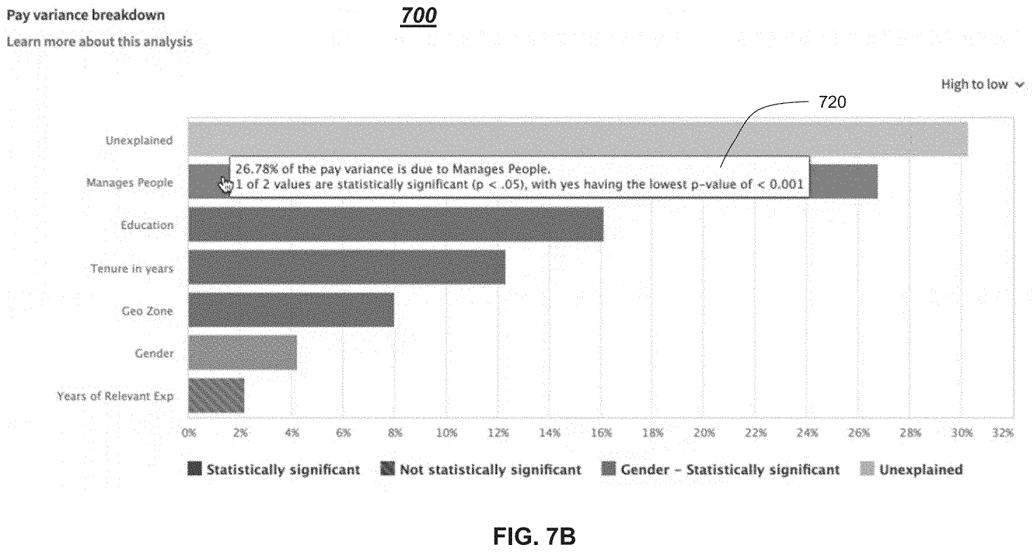

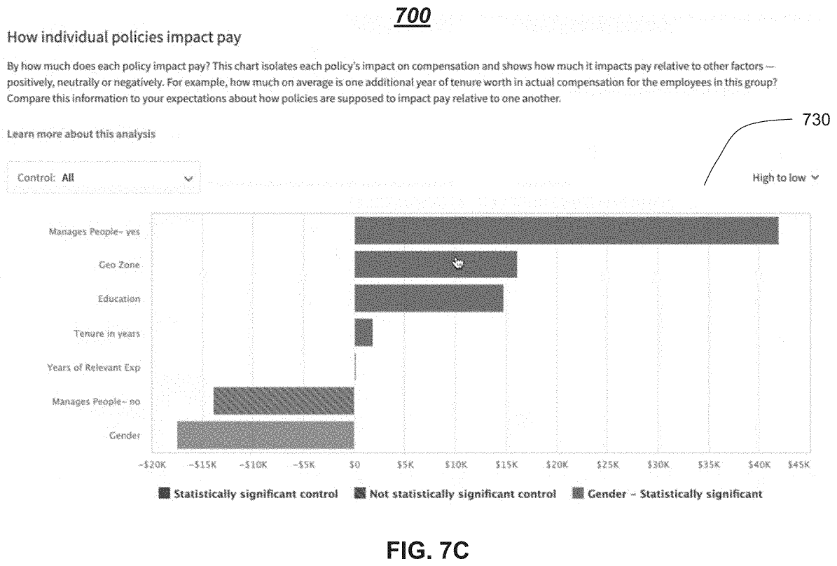

FIGS. 7A to 7C show an example user interface 700 of Pay Policy Analytics. In this example, the system displays diagram 706 to show the statistical variances in pays in relations to the selected controls. As shown in FIG. 7A, the control “Manages People” shows that managing people has the greatest impact on the pay for this group. Window 706 displays numerical statistical variances for the top three controls. In some implementations, when the user hovers a pointing device over a control, the system may display further detail. For example, as shown in FIG. 7B, when the user hovers the mouse over “Manages People,” a pop-up window 720 displays further detail.

FIG. 7C shows an example diagram 730 of the user interface 700. The diagram 730 shows how each control may impact on pay relative to other controls and/or factors.

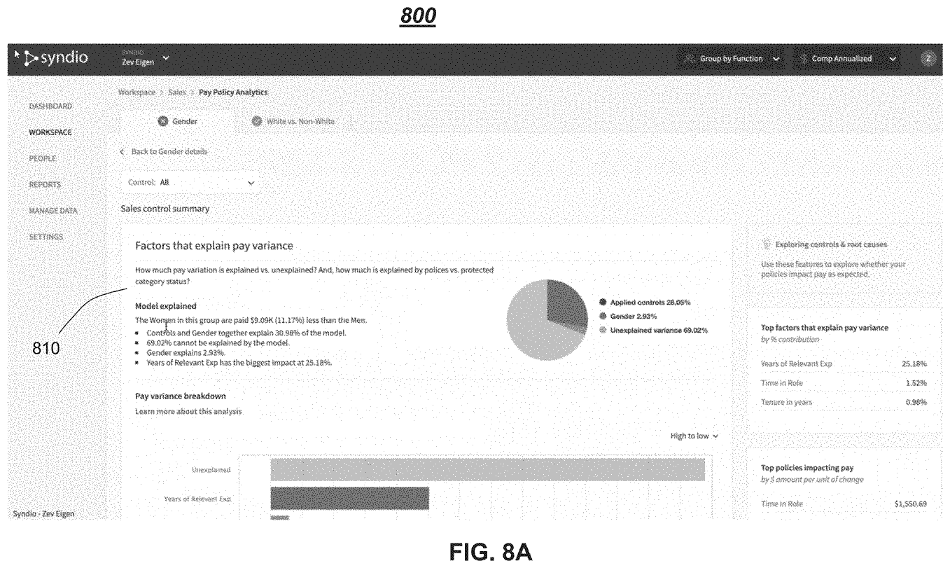

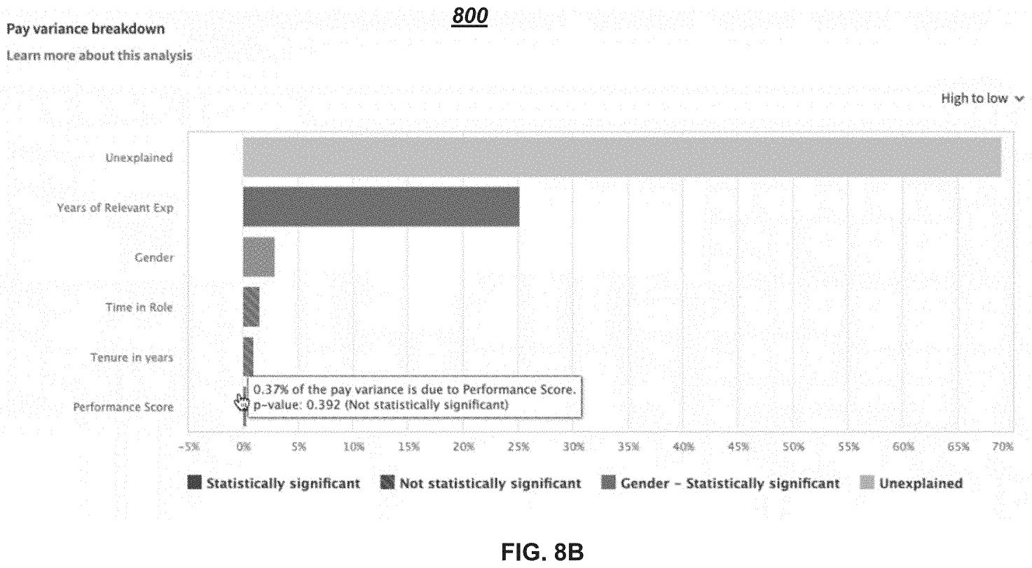

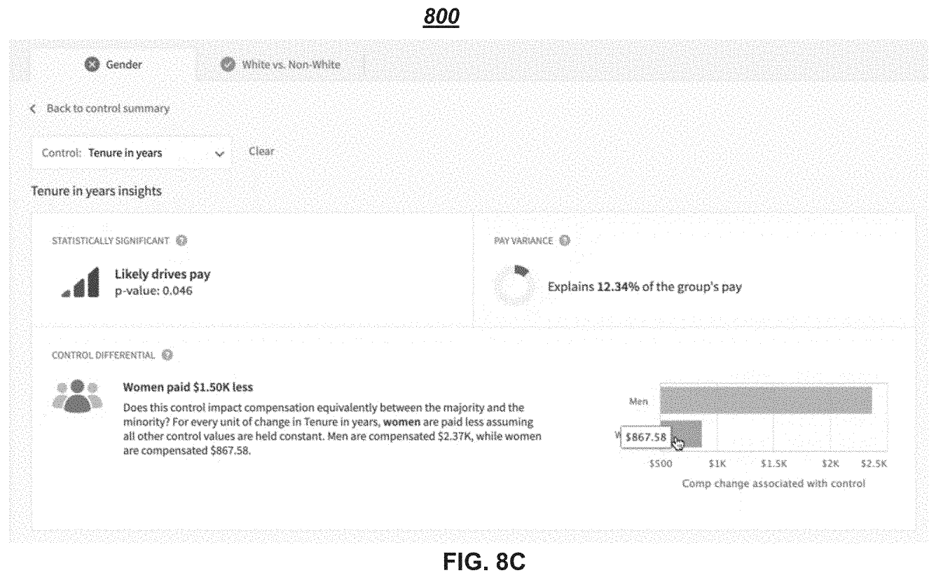

FIGS. 8A to 8C show an example user interface 800 of Pay Policy Analytics. In this example, the system displays analysis based on gender data.

FIGS. 9A to 9D show an example user interface 900 of Pay Finder. In this example, the system displays the internal pay range and equitable pay range, and the pay for current employees and recently hired employees in the relevant group as well as the optimal payment for the prospective new hire being evaluated (FIG. 9A). FIG. 9B shows the display options that are customizable by the user and how to handle errors. FIG. 9C illustrates an example of Pay Finder displaying ranges for specific end users with more limited permissions such as a recruiter.

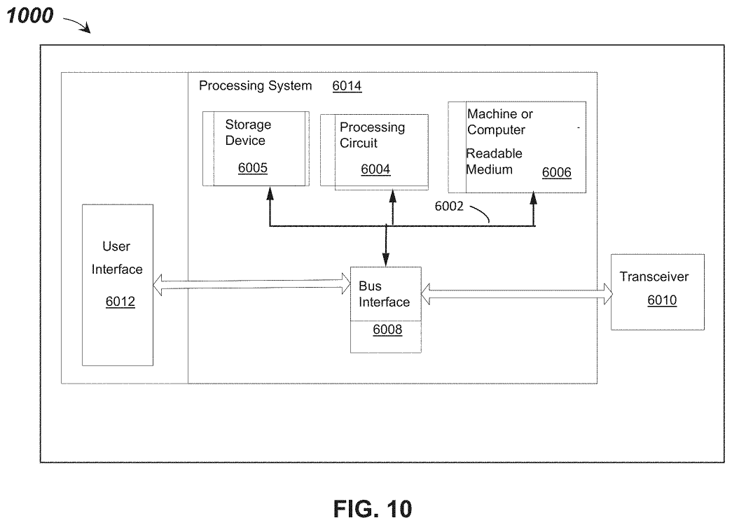

FIG. 10 illustrates an exemplary overall platform (e.g., server, device, etc.) 1000 in which various embodiments, implementations and process steps disclosed herein can be implemented. In accordance with various aspects of the disclosure, an element (for example, a host machine or a microgrid controller), or any portion of an element, or any combination of elements may be implemented with a processing system 1014 that includes one or more processing circuits 1004. Processing circuits 1004 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 1004 may be used to implement any one or more of the various embodiments, systems, algorithms, and processes described above. In some embodiments, the processing system 1014 may be implemented in a server. The server may be local or remote, for example in a cloud architecture.

In the example of FIG. 10, the processing system 1014 may be implemented with a bus architecture, represented generally by the bus 1002. The bus 1002 may include any number of interconnecting buses and bridges depending on the specific application of the processing system 1014 and the overall design constraints. The bus 1002 may link various circuits including one or more processing circuits (represented generally by the processing circuit 1004), the storage device 1005, and a machine-readable, processor-readable, processing circuit-readable or computer-readable media (represented generally by a non-transitory machine-readable medium 1006). The bus 1002 may also link various other circuits such as timing sources, peripherals, voltage regulators, and power management circuits, which are well known in the art, and therefore, will not be described any further. The bus interface 1008 may provide an interface between bus 1002 and a transceiver 1010. The transceiver 1010 may provide a means for communicating with various other apparatus over a transmission medium. Depending upon the nature of the apparatus, a user interface 1012 (e.g., keypad, display, speaker, microphone, touchscreen, motion sensor) may also be provided.

The processing circuit 1004 may be responsible for managing the bus 1002 and for general processing, including the execution of software stored on the machine-readable medium 1006. The software, when executed by processing circuit 1004, causes processing system 1014 to perform the various functions described herein for any apparatus. Machine-readable medium 1006 may also be used for storing data that is manipulated by processing circuit 1004 when executing software.

One or more processing circuits 1004 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

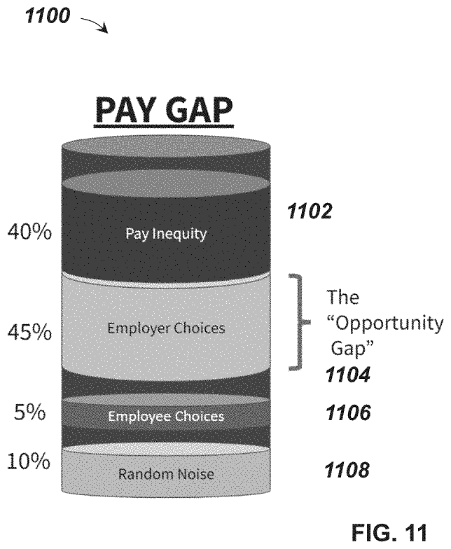

FIG. 11 is a diagram illustrating pay gaps 1100 in accordance with the systems and methods described herein. In some example embodiments, users would use PayEQ to address the portion of the pay gap attributable to pay inequities (including Pay Policy Analytics and Pay Finder) 1102; they would use OppEQ to address the opportunity gap 1104. The remaining variation in the overall pay gap is then due to things beyond the employer's control expressly: employee choices or labor demand effects 1106 and random noise 1108.

The software focuses on identifying the sources or explanations of the pay gap in the organization whose data are being analyzed. The pay gap may be explained, in some examples, by (1) employee choices and actions 1106, and (2) employer choices and actions 1104. Employee choices and actions may include some employees who are members of a protected category (e.g., female) self-selecting into lower paying roles, opting out of or turning down promotions, or self-selecting out of higher paying roles, or voluntarily exiting the workforce instead of advancing. Employer choices and actions may include, for example, pay equity problems, e.g., addressed using the systems and methods described herein. The example company may, for example, disproportionately recruit or hire members of the protected category into lower paying roles. The company may, for example, select men more often than women to be hired into higher paying roles. The example company may, for example, select men for promotion or advancement more often than women. The example company may, for example, select women more frequently than men for involuntary attrition or layoffs. The example company may, for example, have a toxic culture that pushes women out, or does not provide policies or practices likely to retain employee members of the protected category.

In an example embodiment, the systems and methods described herein may address decisions about compensation. For example, the systems and methods described herein may address pay inequality 1102. In some example embodiments, the systems and methods described herein may address decisions about hiring, roles, and promotions. These areas may be referred to as the “opportunity gap” and may be based on employer choices 1104.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

It may not be the case that 100% of the pay gap should be closed all the time for all employers because it is possible or likely that some percentage of the gap is attributable to employee choices and/or employee actions (e.g., employee choices 1106) or it may be attributable to noise and/or random statistical error/variation (e.g., random noise 1108). The focus must therefore be placed on addressing the components of the pay gap within the employer's control—namely, addressing pay equity with PayEQ first, (addressing policies with Pay Policy Analytics and ongoing compensation equity concerns with Pay Finder), and next addressing opportunity equity with OppEQ, e.g., using the systems and methods in the particular sequence described herein.

An example embodiment may show a customer's progress toward reducing the gap over time in terms of cents on the dollar and actual total dollar gap. An example embodiment may follow the following sequence: (1) evaluate unadjusted gap (e.g., average and median total annualized compensation, organization-wide): (2) use the systems and methods described herein to achieve pay equity; (3) evaluate how much this closes the overall pay gap (4) use the systems and methods described herein to see which policies and practices are biased; (5) use the systems and methods described herein to maintain pay equity, by using features such as Pay Finder and others; (6) use the systems and methods described herein to evaluate deficiencies in opportunities for hiring, promotion, performance evaluation and retention (“OppEQ” or “Opportunity EQ”); (7) Evaluate the remaining pay gap following these processes.

An example embodiment may use the systems and methods described herein to evaluate where headcount deficiencies are occurring at the top and/or bottom of the organization. An example embodiment may use the systems and methods described herein to allow users to make recommendations about specific (a) people, (b) groups, (c) policies and practices, and (d) opportunities for future areas of improvement. An example embodiment may use the systems and methods described herein to provide a goal forecaster/calibrator to generate realistic expectations and action plans over time.

An example embodiment may use the systems and methods described herein to determine whether the unadjusted (or “raw”) or adjusted gap is statistically significant to rule out whether it is likely occurring non-randomly because of a protected category status or statuses.

In an example embodiment, if there remains a gap following the seven steps in the sequence outlined above, if the gap is not statistically significant, users may be offered messaging around why that remaining gap is random noise, or otherwise not necessarily addressable economically.

In an example embodiment, when the remaining pay gap is statistically significant, or even if the gap is not significant, but the customer wants to get to “100 cents on the dollar,” an example may use the systems and methods described herein to optimally pay out the remaining dollars to close the gap to be 100 cents on the dollar.

In an example, a system may determine that current pay is $0.85 cents on the dollar, e.g., for a certain predetermined protected class for a total pay of $1.4 million for 10,000 employees. Pay equity may be improved to $0.94 on the dollar at a cost of $1.2 million for 4,000 employees. Pay equity may be improved to $0.97 on the dollar for $100,000 for 1,000 employees.

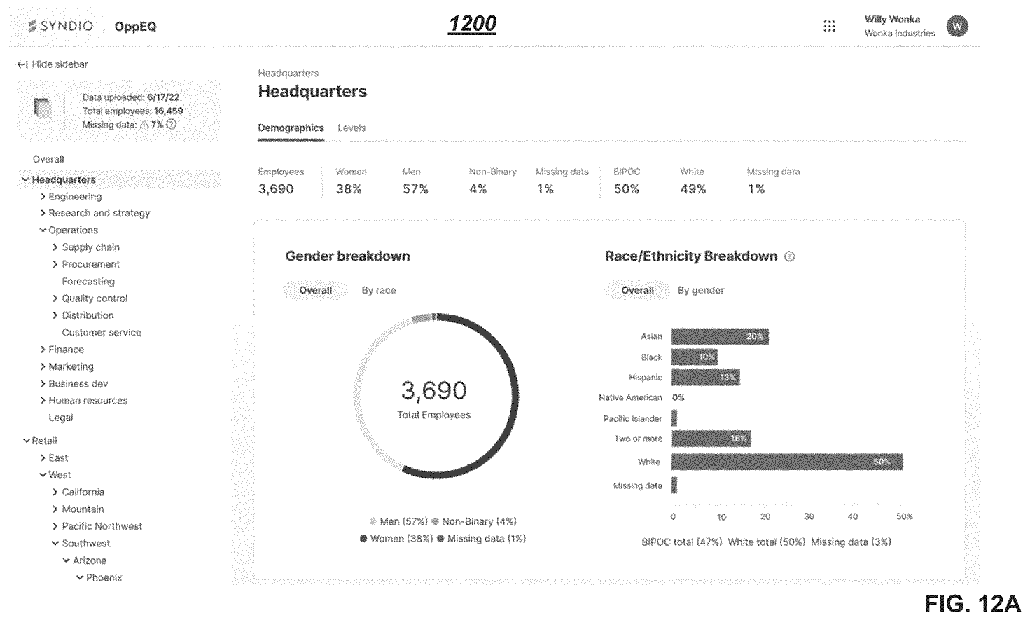

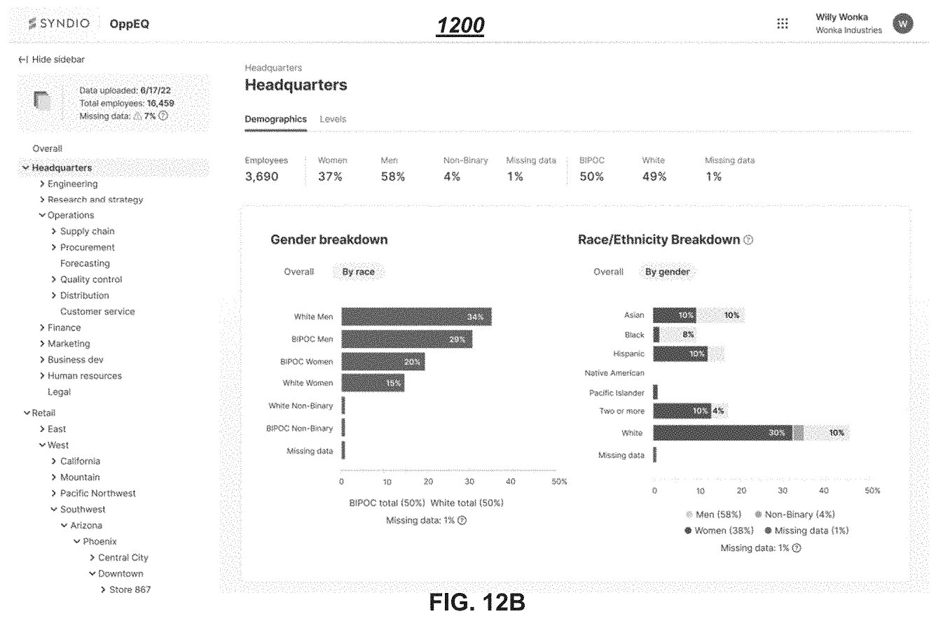

FIG. 12A to 12B illustrate an example user interface of OppEQ Representation. In these examples, the system displays representation breakdown charts of the user's selected population based on, respectively, gender and race data. Each chart can be further broken down by race and gender to provide an intersectional view of the data.

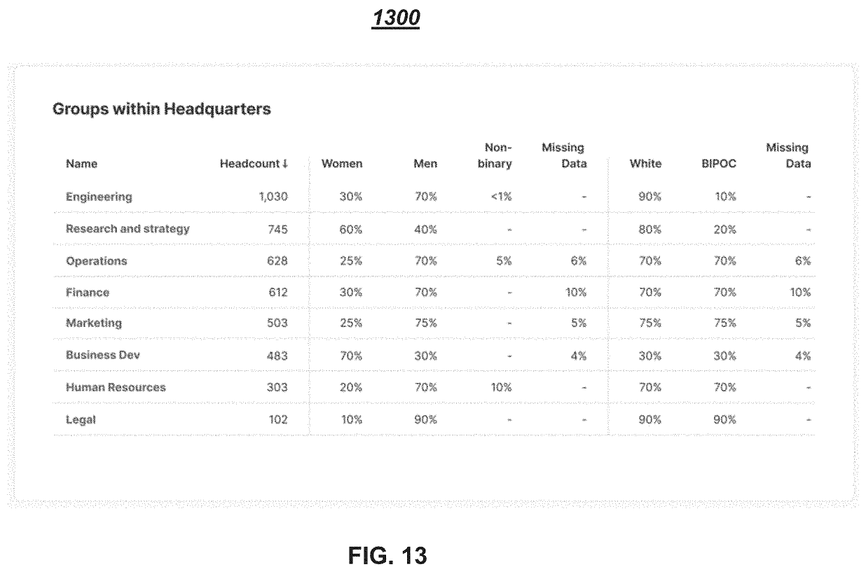

FIG. 13 illustrates an example user interface of OppEQ Representation. In this example, the system displays a table of job levels associated with the user's selected population and, based on gender and race data, shows the headcount associated with each job level along with its gender and race percentages. The user can drill further into each level for additional cuts of data.

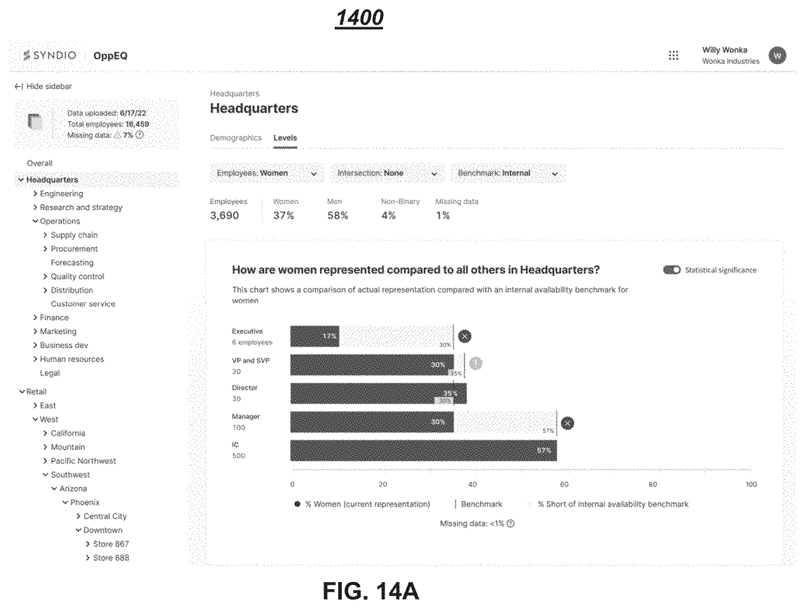

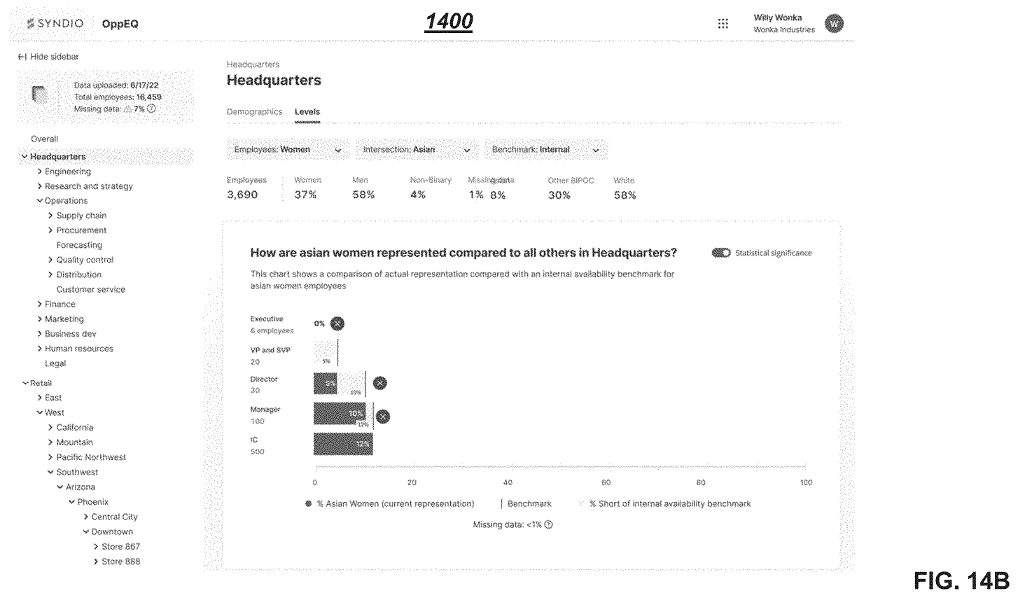

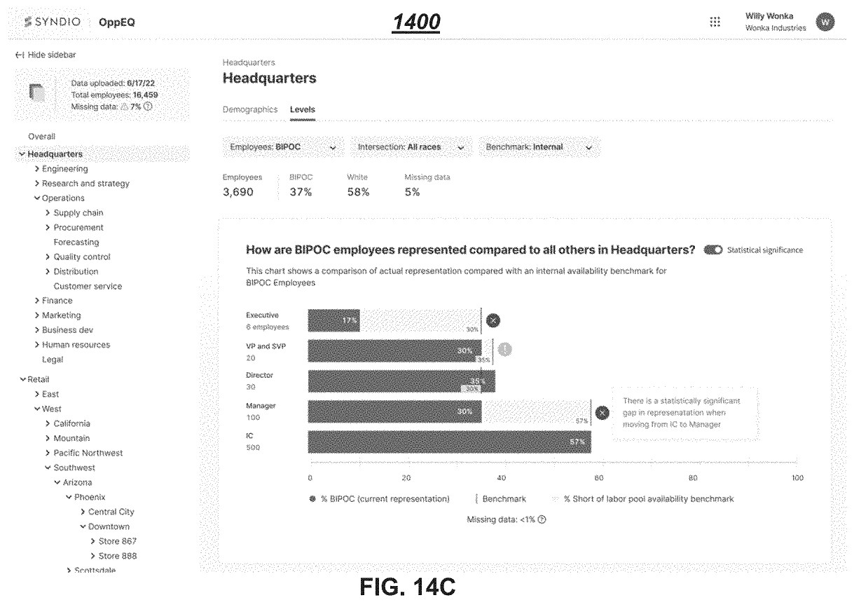

FIG. 14A to 14C illustrate an example user interface of OppEQ Representation. In these examples, the system displays the representation of a selected group and compares it with the representation of the broader gender or racial/ethnic category to which the employees belong, broken down by level.

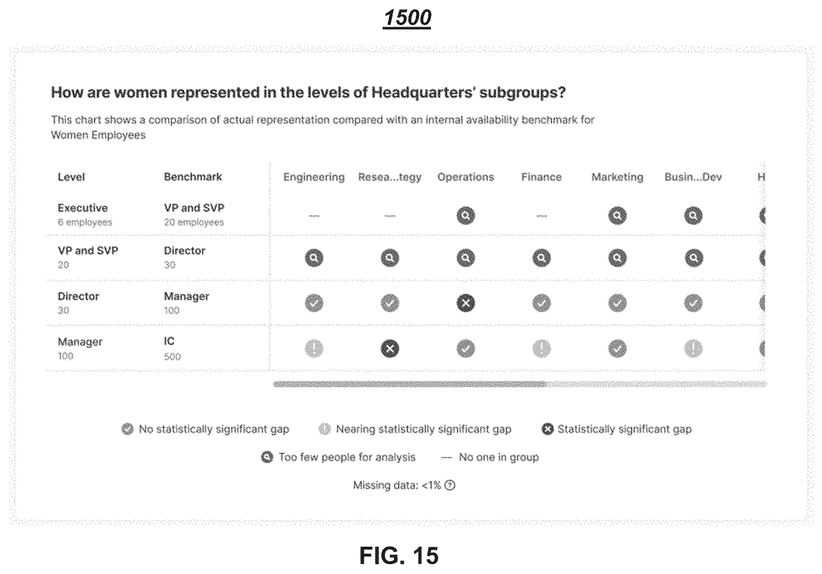

FIG. 15 illustrates an example user interface of OppEQ Representation. In this example, the system displays a high-level view of the levels associated with the user's selected population and, based on gender, race and benchmark data, reveals statistically significant gaps where representation falls short of availability. The user can view internal and labor pool benchmarks.

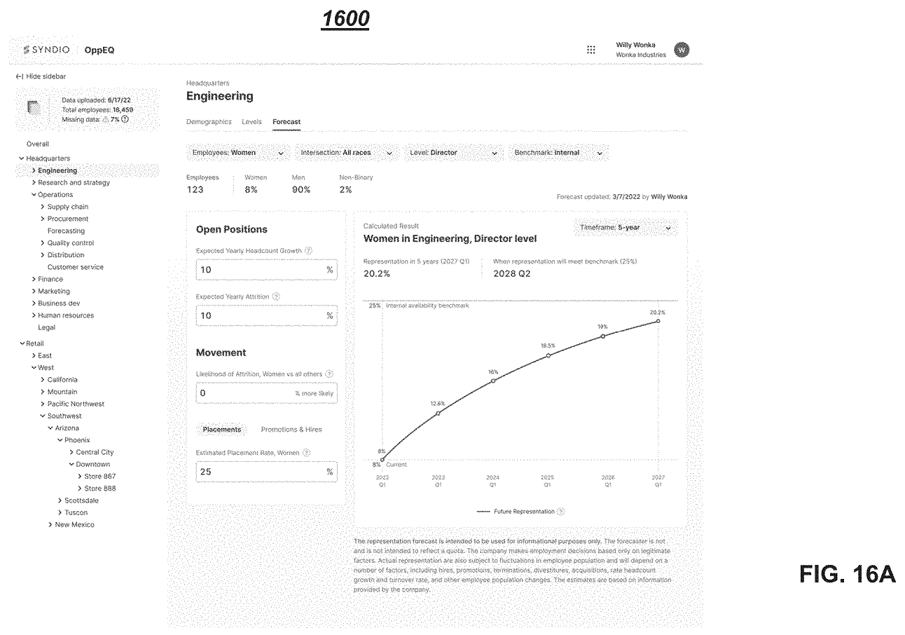

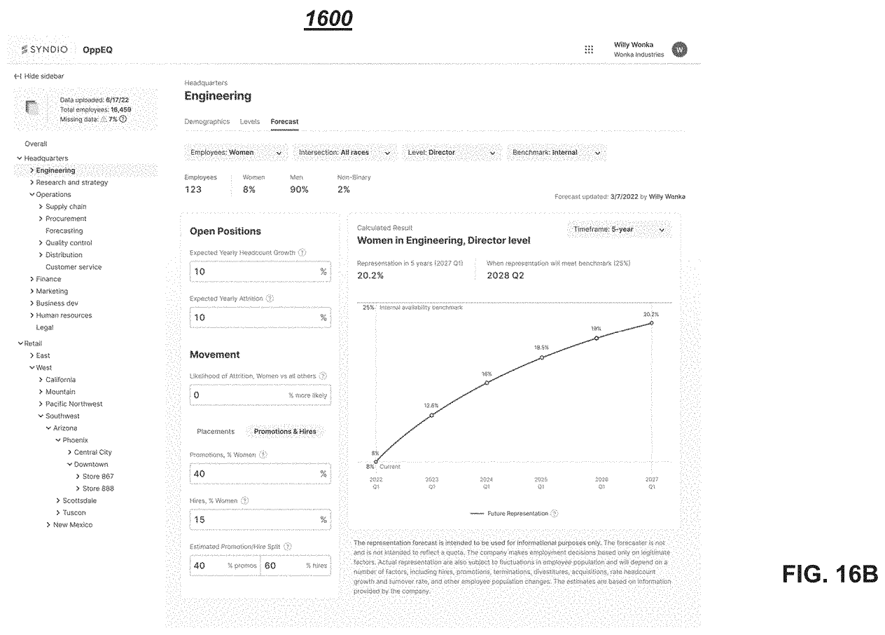

FIG. 16A to 16B illustrate an example user interface of OppEQ Forecaster. In these examples, the system displays an interactive projection for a company's expected future representation of employees within a given protected category, based on their current representation and key headcount growth indicators, and compares it with a selected reference target based on available talent internally or internally and externally.

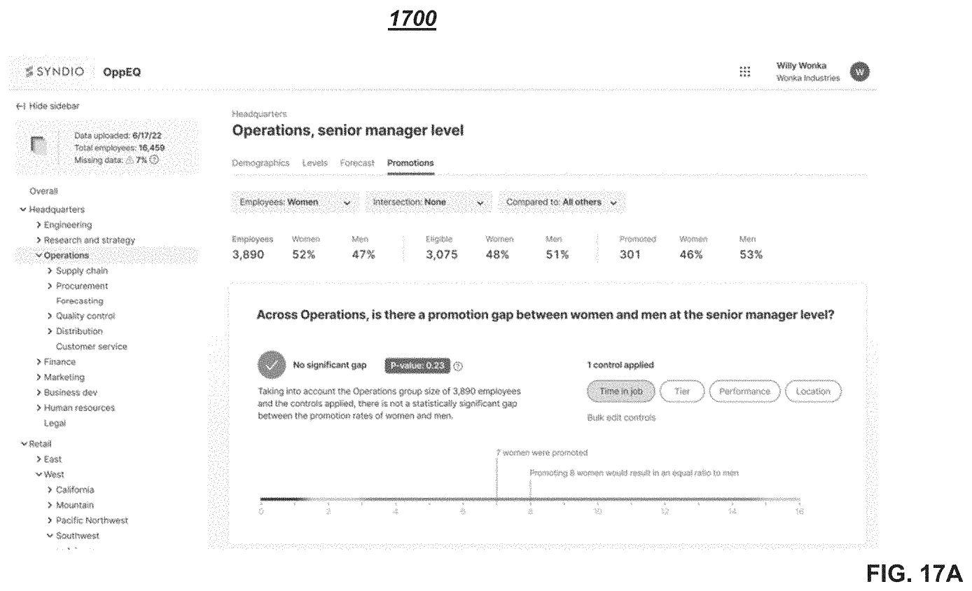

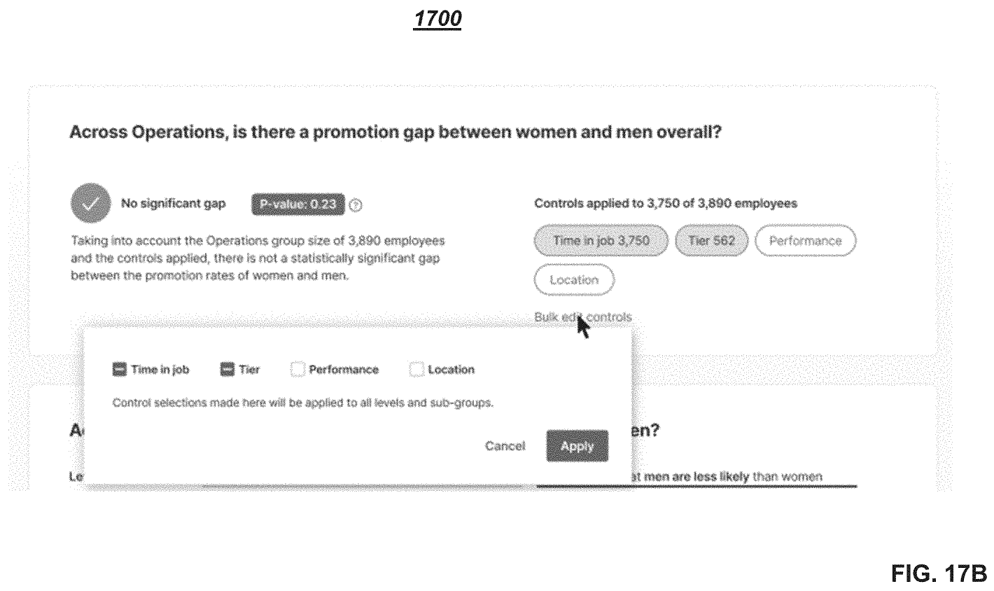

FIG. 17A illustrates an example user interface of OppEQ Equitable Movement. In these examples, the system displays whether, based on gender and race data, there's a statistically significant promotions gap within the user's selected population taking into account the group size and the controls applied. The user can view different cuts of the data by selecting an employee protected class (e.g., women), an intersection (e.g., BIPOC) and a comparison group (e.g., men). FIG. 17B illustrates an example user interface for applying controls.

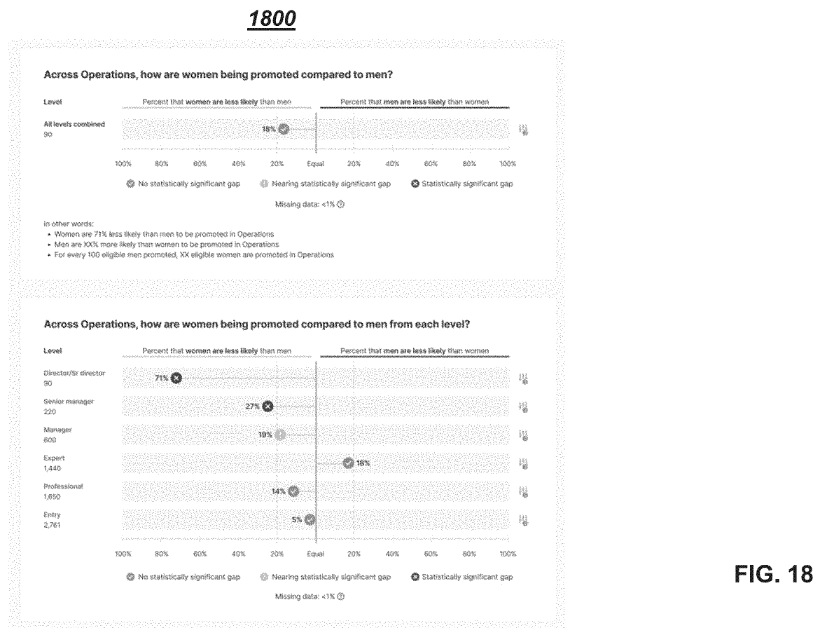

FIG. 18 illustrates an example user interface of OppEQ Equitable Movement. In this example, the system displays the likelihood overall of the selected protected class within the user's selected population to be promoted relative to the reference group (e.g., the likelihood of women being promoted compared to men). The user can view all levels combined (top) or specific levels (bottom).

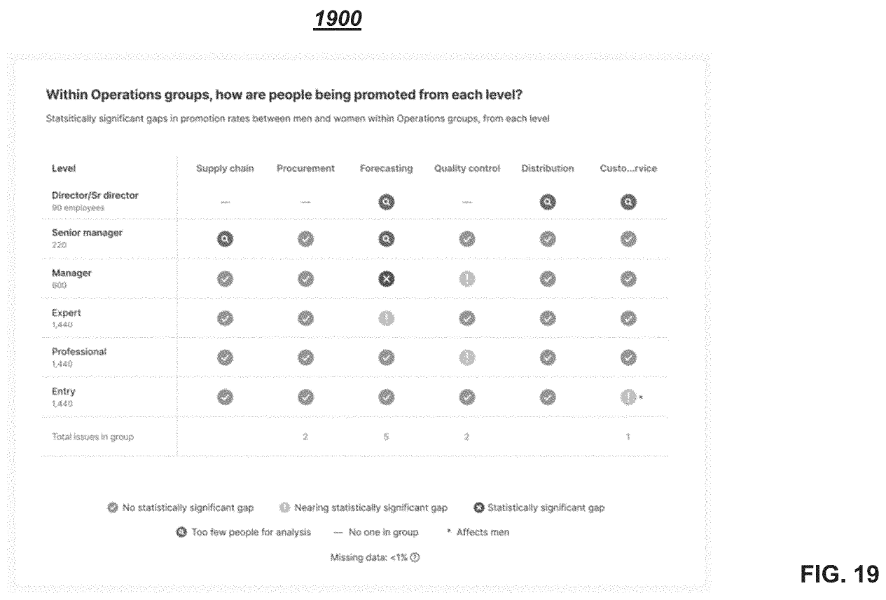

FIG. 19 illustrates an example user interface of OppEQ Equitable Movement. In this example, the system displays a high-level view of the levels associated with the user's selected population and, based on gender and race, reveals any statistically significant promotion gaps.

Disclosed are example embodiments of methods and systems for analyzing and determining impact (or lack thereof) on any selected group or groups of employees of selected pay policies, which include compensation decisions, and decisions about employee placement (hiring, promotions, lateral movements, and other changes in employment status). Starting with the analysis of unadjusted and adjusted pay gap figures for an organization, the sequence requires first the review of compensation (PayEQ). An example includes a computer-implemented method for analyzing and determining impact on selected group of employees of selected pay policies. The method includes receiving a first set of pay data for the selected group of employees. The method also includes determining one or more controls for the selected group of employees. Additionally, the method includes calculating an equitable pay range for the selected group of employees based on the one or more controls. The method also includes receiving a user input, wherein the user input requests a second set of pay data relates to an employee, and is based on a selected control. The method also includes calculating the second set of pay data; and sending the second set of pay data for display. The steps following this include the methods and systems for review of other decision points within the employer's control (OppEQ). An example includes a computer-implemented method for analyzing rates of hiring and promotion into various strata of the organization by gender, race and other protected category characteristics. This method also includes algorithmic matching of job titles with standard occupational classification (SOC) codes using machine learning techniques so that the user can adequately evaluate the degree to which the rates of opportunities for different protected category groups are similar or dissimilar from a statistical vantage. This method also includes analysis and reporting on promotion rates over time by protected category, as well as other forms of movement in the organization.

In an example embodiment, one or more of the different analytics or analysis discussed above may be grouped within workplace analytics. In an example embodiment, an example process may analyze any overall gap, then perform one or more of the aspects described herein, such as, for example, PayEQ, Pay Finder, and Pay Policy Analytics. An example embodiment may also perform an OppEq.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A computer-implemented method for analyzing and determining impact on selected group of employees of selected pay policies, the method comprising:
receiving a first set of pay data for the selected group of employees;
determining one or more controls for the selected group of employees;
calculating an equitable pay range for the selected group of employees based on the one or more controls;
receiving a user input, wherein the user input requests a second set of pay data relates to an employee, and is based on a selected control;
calculating the second set of pay data; and
sending the second pay set of data for display.

2. The computer-implemented method of claim 1, wherein the one or more controls for the selected group of employees is at least one of geographical, time in a role, age, gender, years of relevant experience, tenure in years, level, management, performance score, education, and legacy.

3. The computer-implemented method of claim 1, wherein the selected control one of geographical, time in a role, age, gender, years of relevant experience, tenure in years, level, management, performance score, education, and legacy.

4. The computer-implemented method of claim 1, wherein the second set of pay data is a pay range.

5. The computer-implemented method of claim 1, further comprising evaluating an unadjusted pay gap.

6. The computer-implemented method of claim 1, further comprising evaluating an adjusted pay gap.

7. The computer-implemented method of claim 1, further comprising adjusting a pay gap.

8. The computer-implemented method of claim 7, further comprising evaluating an adjusted pay gap to determine when a pay gap remains.

9. The computer-implemented method of claim 8, further comprising adjusting the remaining pay gap.

10. The computer-implemented method of claim 8, further comprising determining when the remaining pay gap is statistically significant.

11. A system for analyzing and determining impact on selected group of employees of selected pay policies, the system comprising:
a memory; and
at least one processor, coupled to the memory, the memory including instructions causing the processor to:
receive a first set of pay data for the selected group of employees;
determine one or more controls for the selected group of employees;
calculate an equitable pay range for the selected group of employees based on the one or more controls;
receive a user input, wherein the user input requests a second set of pay data relates to an employee, and is based on a selected control; and
calculate the second set of pay data; and sending the second pay set of data for display.

12. The system of claim 11, wherein the one or more controls for the selected group of employees is at least one of geographical, time in a role, age, gender, years of relevant experience, tenure in years, level, management, performance score, education, and legacy.

13. The system of claim 11, wherein the selected control one of geographical, time in a role, age, gender, years of relevant experience, tenure in years, level, management, performance score, education, and legacy.

14. The system of claim 11, wherein the second set of pay data is a pay range.

15. The system of claim 1, further comprising evaluating an unadjusted pay gap.

16. The system of claim 1, further comprising evaluating an adjusted pay gap.

17. The system of claim 1, further comprising adjusting a pay gap.

18. The system of claim 7, further comprising evaluating an adjusted pay gap to determine when a pay gap remains.

19. The system of claim 8, further comprising adjusting the remaining pay gap.

20. The system of claim 8, further comprising determining when the remaining pay gap is statistically significant.
